(19) United States
(12) Patent Application Publication
(10) Pub. No.: US 2017/0024027 A1
(43) Pub. Date: Jan. 26, 2017

(54) INPUT DEVICE

(71) Applicant: Primax Electronics Ltd., Taipei (TW)

(72) Inventor: CHIH-FENG CHIEN, Taipei (TW)

(21) Appl. No.: 14/921,318

(22) Filed: Oct. 23, 2015

(30) Foreign Application Priority Data
Jul. 24, 2015 (TW) 104124092

(51) Int. Cl. G06F 3/0362; G09G 5/00; G06F 3/023

(52) U.S. Cl. CPC G06F 3/0362; G06F 3/0231; G09G 5/003; G09G 2370/16

(57) ABSTRACT

An input device includes an input interface, a near field communication unit and a controlling unit. The near field communication unit receives a device setting information from a portable electronic device. Consequently, the controlling unit reads the device setting information and performs an input setting task corresponding to the device setting information. When the user operates the input interface, a personalized operating signal corresponding to the device setting information is transmitted from the input interface to a computer host that is connected with the input device. Consequently, the computer host performs a corresponding operation. Under this circumstance, it is not necessary to install a corresponding driver in the computer host.

### FIELD OF THE INVENTION

The present invention relates to an input device, and more particularly to an input device capable of generating a personalized operating signal according to settings.

### BACKGROUND OF THE INVENTION

The widely-used peripheral input device of a computer system includes for example a mouse device, a keyboard device, a trackball device, or the like. Generally, the peripheral input device is connected with a computer host. Via the peripheral input device, the user can control the operations of the computer host.

With increasing development of science and technology, the manufacturers of input devices make efforts in designing novel input devices with diversified functions so as to meet the requirements of various users. For example, the functions of the novel input devices include a wireless transmission function, an illuminating function or a composite key (or a hot key) function. The composite key function and the hot key function are special functions that are preset by the user. When plural keys corresponding to the composite key function are simultaneously depressed or sequentially depressed, a corresponding composite key signal is generated. Consequently, the computer host performs an operation corresponding to the composite key signal. Similarly, when an additional button corresponding to the hot key function is depressed by the user, a corresponding hot key signal is generated. Consequently, the computer host performs an operation corresponding to the hot key signal.

Take a keyboard as an example of the input device. FIG. 1 schematically illustrates the relationship between a conventional keyboard and a computer system. In FIG. 1, the conventional keyboard 1 and the computer system 2 are shown. The computer system 2 comprises a computer host 21 and a display screen 22. The keyboard 1 is connected with the computer host 21. Moreover, the keyboard 1 comprises plural keys 11. When one of the keys 11 is depressed by the user, a corresponding key signal is generated to the computer host 21. Consequently, the computer host 21 performs an operation corresponding to the key signal. In addition, the conventional keyboard 1 has a composite key function. Consequently, a driver 12 corresponding to the keyboard 1 has to be installed in the computer host 21. When the driver 12 is executed, the computer host 21 can recognize the composite key signal that is provided by the keyboard 1.

For example, a composite key of the conventional keyboard 1 is the combination of the Q key, the W key and the E key. In addition, the combination of the Q key, the W key and the E key has been previously defined in the driver 12. When the Q key, the W key and the E key are simultaneously depressed by the user or depressed in a specified manner, plural key signals corresponding to the Q key, the W key and the E key are transmitted from the conventional keyboard 1 to the computer host 21. In addition, the plural keys signals are collaboratively defined as a composite key signal. According to the settings of the driver 12, the computer host 12 recognizes that the plural key signals corresponding to the Q key, the W key and the E key represent the composite key signal and do not represent the individual key signals of the Q key, the W key and the E key. Consequently, the computer host 21 performs a corresponding operation according to the composite key signal. That is, the computer host 21 executes a specified command that is set by the user. For example, when the specified command is executed, a pop-up window is opened or an input method is changed.

However, for implementing the composite key function, it is necessary to install the corresponding driver 12 in the computer host 21 of the conventional keyboard 1. When the user operates an additional computer host or an additional keyboard, the composite key function cannot be implemented successfully. As known, the driver 12 has to be previously installed in the additional computer host. In other words, the user has to canary the driver 12 in order to install the driver 12 in the additional computer host 21. For carrying the driver 12, the driver 12 is burnt into an optical disc, or the driver 12 is stored in a portable storage device (e.g., a flash drive).

From the above discussions, the user has to carry the driver 12 in order to perform the above personalized operating function (including the composite key function). Generally, it is troublesome for most users to the carry the driver 12 and to install the driver 12 in the computer host. In addition, the user may easily forget to carry the driver 12.

Therefore, there is a need of providing an input device for performing a personalized operating function without using a driver.

### SUMMARY OF THE INVENTION

An object of the present invention provides an input device for performing a personalized operating function without using a driver.

In accordance with an aspect of the present invention, there is provided an input device. The input device is connected with a computer host. The input device includes an input interface, a near field communication unit and a controlling unit. The input interface issues an operating signal to the computer hot in response to an operation of a user on the input interface. The near field communication unit receives a device setting information and temporarily stores the device setting information. The controlling unit is connected with the input interface and the near field communication unit, and reads the device setting information. After an input setting task corresponding to the device setting information is performed on the input device by the controlling unit, a personalized operating signal corresponding to the device setting information is issued from the input interface to the computer system in response to the operation of the user.

From the above descriptions, the input device of the present invention comprises the near field communication unit. The near field communication unit receives the device setting information from the portable electronic device. After the input setting task corresponding to the device setting information is implemented, the input device has the personalized operating function. Since the input setting task is performed by the controlling unit of the input device, it is not necessary to install a driver in the computer host. For transmitting the device setting information, the device setting information is temporarily stored in the portable electronic device that is carried by the user every day. Consequently, the possibility of forgetting to carry the device setting information will be minimized. Moreover, the input device of the present invention receives the device setting information by the near field communication technology, and the electric power to the near field communication unit of the input device is provided by the portable electronic device. Consequently, the input device has the power-saving benefit.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the relationship between a conventional keyboard and a computer system;

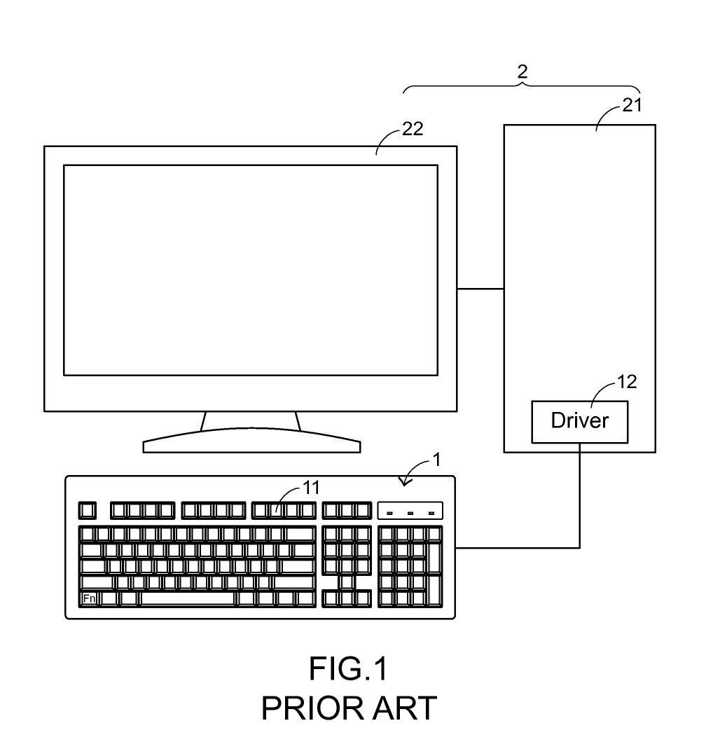

FIG. 2 is a schematic block diagram illustrating the relationships between an input device, a computer host and a portable electronic device according to an embodiment of the present invention; and

FIG. 3 is a flowchart illustrating a process of transmitting the device setting information from the near field communication unit of the input device to the computer host according to an embodiment of the present invention.

### DETAILED DESCRIPTION OF THE PREFERRED EMBODIMENT

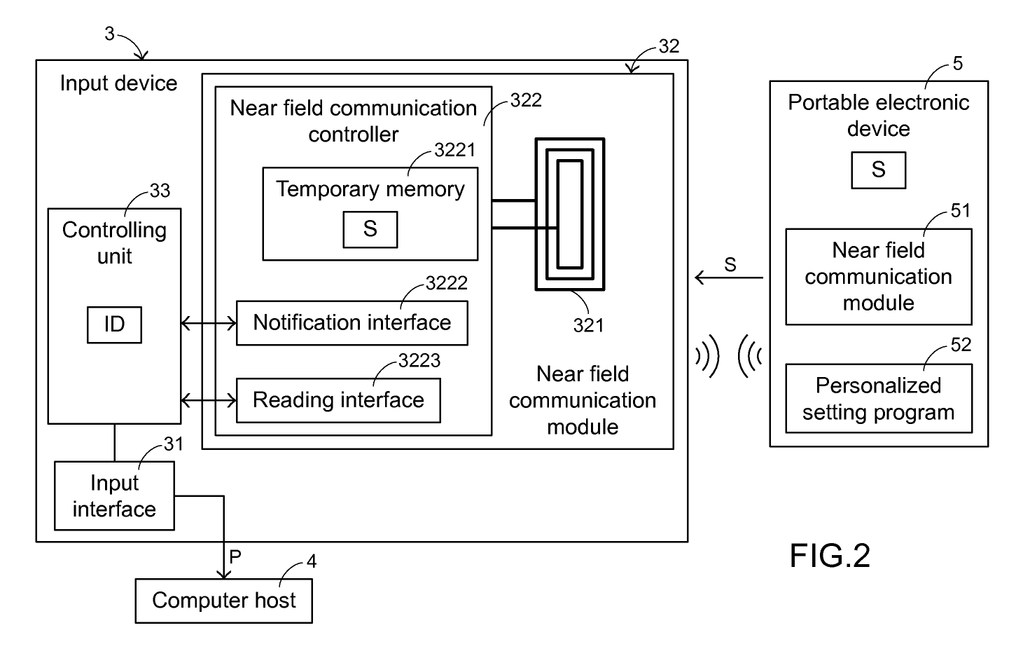

For solving the drawbacks of the conventional technologies, the present invention provides an input device. Hereinafter, the architecture of an input device of the present invention will be illustrated with reference to FIG. 2. FIG. 2 is a schematic block diagram illustrating the relationships between an input device, a computer host and a portable electronic device according to an embodiment of the present invention. In FIG. 2, the input device 3, the computer host 4 and the portable electronic device 5 are shown. The input device 3 is connected with the computer host 4 by a wired transmission technology or a wireless transmission technology. The input device 3 comprises an input interface 31, a near field communication unit 32 and a controlling unit 33. The input interface 31 is exposed outside the input device 3. In response to an operation of the user, the input interface 31 issues a corresponding operating signal to the computer host 4. In this embodiment, the input device 3 is a keyboard, and the input interface 31 comprises plural keys. The examples of the input device and the input interface are presented herein for purpose of illustration and description only. In another embodiment, the input device is a mouse, and the input device is a mouse button or a scroll wheel.

The near field communication unit 32 is used for receiving a device setting information S from the portable electronic device 5 and temporarily storing the device setting information S. In this embodiment, the near field communication unit 32 comprises an antenna 321 and a near field communication controller 322. The antenna 321 is disposed within the inputs device 3. The antenna 321 can receives the device setting information S and the electric power from the portable electronic device 5 by a near field communication technology. The near field communication controller 322 is connected with the antenna 321. The near field communication controller 322 can temporarily stores the device setting information S and transmit the device setting information S to the controlling unit 33. The controlling unit 33 is connected with the input interface 31 and the near field communication unit 32. The controlling unit 33 is used for reading the device setting information S and performing an input setting task of the input device 3 corresponding to the device setting information S. Moreover, an identification code ID has been previously stored in the controlling unit 33. According to the identification code ID, the portable electronic device 5 can identify that the wirelessly-connected device is the input device 3. In this embodiment, the controlling unit 33 is a microprocessor or a control chip.

The near field communication controller 322 comprises a temporary memory 3221, a notification interface 3222 and a reading interface 3223. The temporary memory 3221 is connected with the antenna 321. The received device setting information S is temporarily stored in the temporary memory 3221. The notification interface 3222 is disposed on the near field communication controller 322 and connected with the controlling unit 33. The notification interface 3222 is used for notifying the controlling unit 33 to read the device setting information S from the near field communication controller 322. The reading interface 3223 is disposed on the near field communication controller 322 and connected with the controlling unit 33. Via the reading interface 3223, the controlling unit 33 can read the device setting information S from the near field communication controller 322. In this embodiment, the temporary memory 3221 is a flash memory or an electrically-erasable programmable read-only memory (EEPROM).

Please refer to FIG. 2 again. The portable electronic device 5 comprises a near field communication module 51. After the wireless communication between the near field communication module 51 and the antenna 321 is established by a near field communication technology, the portable electronic device 5 is in wireless communication with the input device 3. Moreover, a personalized setting program 52 is installed in the portable electronic device 5 by the user. Via the personalized setting program 52, the user can perform a setting operation to generate the corresponding device setting information S. Moreover, the device setting information S is transmitted from the personalized setting program 52 to the input device 3 through the near field communication module 51. While the user performs the setting operation on the input device 3, the user provides the identification code ID of the input device 3 to the portable electronic device 5. Consequently, the identification code ID links with the device setting information S corresponding to the input device 3. Consequently, according to the identification code ID, the personalized setting program 52 realizes that the device setting information S corresponds to the input device 3. In an embodiment, the portable electronic device 5 is a smart phone. It is noted that the example of the portable electronic device is not restricted. In another embodiment, the portable electronic device is a near field communication reader or a near field communication writer.

A process of operating the portable electronic device 5 to control the computer host 4 to perform the input setting task on the input device 3 will be illustrated as follows. Firstly, the user opens the personalized setting program 52 of the portable electronic device 5. Then, the key combination of the desired composite key (e.g., the combination of the Q key, the W key and E key) is inputted into the personalized setting program 52. In addition, the identification code ID corresponding to the input device 3 is provided to the personalized setting program 52. Consequently, the device setting information S corresponding to the identification code ID is created in the personalized setting program 52. In an embodiment, the device setting information S contains the information about the key combination of the desired composite key.

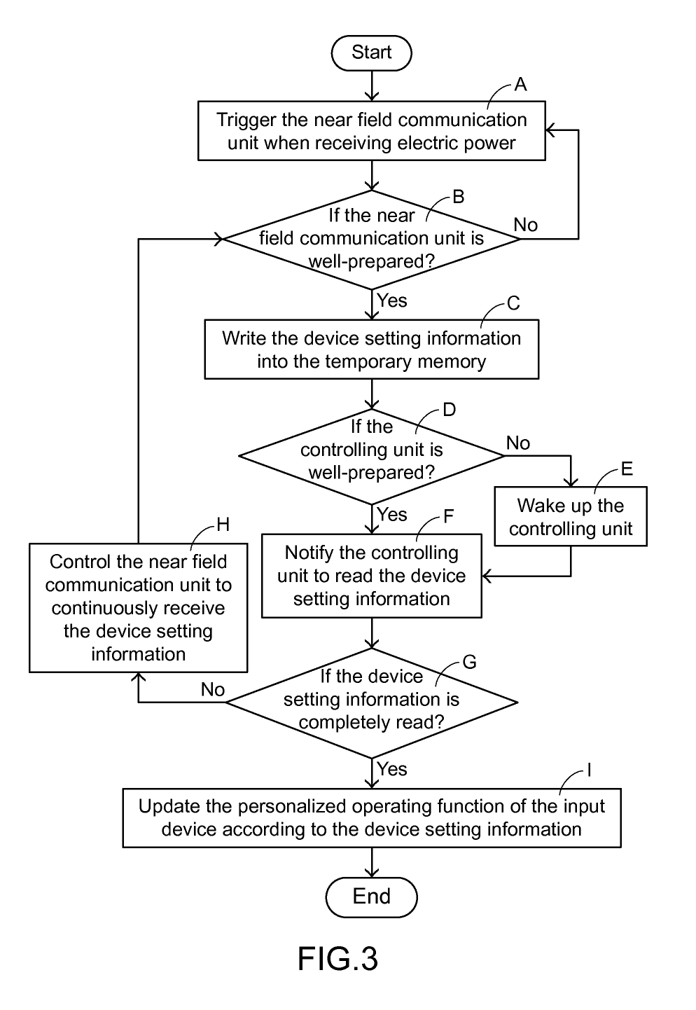

Please refer to FIGS. 2 and 3. FIG. 3 is a flowchart illustrating a process of transmitting the device setting information from the near field communication unit of the input device to the computer host according to an embodiment of the present invention. As shown in FIG. 3, the process comprises the following steps. In a step A, the near field communication unit is triggered when receiving electric power. A step B is performed to judge whether the near field communication unit is well-prepared. In a step C, the device setting information is written into the temporary memory. A step D is performed to judge whether the controlling unit is well-prepared. In a step E, the controlling unit is waked up. In a step F, the controlling unit is notified to read the device setting information. A step G is performed to judge whether the device setting information is completely read. In a step H, the near field communication unit is controlled to continuously receive the device setting information. In a step I, the personalized operating function of the input device is updated according to the device setting information.

After the device setting information S is created by the personalized setting program 52, the user may take out the portable electronic device 5. When the user wants to operate the computer host 4, the user may move the portable electronic device 5 and allow the portable electronic device 5 to be in contact with the input device 3. By the near field communication technology, the near field communication module 51 of the portable electronic device 5 is in wireless communication with the antenna 321 of the input device 3. Meanwhile, the input device 31 performs the step A. That is, the near field communication controller 322 is triggered when the near field communication controller 322 receives the electric power from the portable electronic device 5. Then, the step B is performed to judge whether the near field communication unit 32 is well-prepared according to the result of judging whether the near field communication unit 32 is powered on and enabled. If the near field communication unit 32 is enabled, the step C is performed. Whereas, if the near field communication unit 32 is not enabled, the step A is repeatedly done.

After the near field communication unit 32 is enabled, the identification code ID corresponding to the input device 3 is transmitted from the near field communication controller 322 to the near field communication module 51 through the antenna 321. Consequently, the personalized setting program 52 searches the device setting information S corresponding to the identification code ID from the portable electronic device 5 according to the identification code ID. Then, the device setting information S corresponding to the identification code ID is transmitted from the personalized setting program 52 to the antenna 321, and the device setting information S is temporarily stored in the temporary memory 3221. That is, the step C is performed. Since the storage space of the temporary memory 3221 is limited, only a portion of the device setting information S is temporarily stored in the temporary memory 3221 for each time.

Then, the step D is performed to judge whether the controlling unit 33 is well-prepared. That is, the near field communication controller 322 judges whether the controlling unit 33 is in a sleep mode. If the near field communication controller 322 judges that the controlling unit 33 is in the sleep mode, the step E is performed to wake up the controlling unit 33. Whereas, if the near field communication controller 322 judges that the controlling unit 33 is not in the sleep mode, the step F is performed. After the controlling unit 33 is waked up in the step E, the step F is continuously performed. In particular, if the near field communication controller 322 judges that the controlling unit 33 is not in the sleep mode, the near field communication controller 322 notifies the controlling unit 33 to read the portion of the device setting information S from the temporary memory 3221 through the notification interface 3222. Moreover, the portion of the device setting information S is transmitted to the controlling unit 33 through the reading interface 3223 of the near field communication controller 322. Consequently, the device setting information S is read by the controlling unit 33. On the other hand, if the near field communication controller 322 judges that the controlling unit 33 is in the sleep mode, the near field communication controller 322 wakes up the controlling unit 33 through the notification interface 3222. Consequently, the controlling unit 33 is waked up from the sleep mode.

Regardless of whether the step E or the step F is earlier, the step F has to be performed after the step D. Moreover, after the step F, the near field communication controller 322 will perform the step G to judge whether the device setting information S is completely read. For example, the near field communication controller 322 can realize that the device setting information S is divided into plural files according to the information (e.g., the header files) of the portion of the device setting information S that is temporarily stored in the temporary memory 3221. Consequently, the near field communication controller 322 performs the judging operation of the step G according to the header files. The technologies of the header files are well known in the art, and are not redundantly described herein.

Since the near field communication controller 322 judges that the device setting information S is not completely read in the step G, the step H will be performed. In the step H, the near field communication unit 32 is controlled to continuously receive the device setting information S. Then, the step B is performed again, and the steps C, D, F and G are repeatedly done. These steps are repeatedly done until the near field communication controller 322 judges that the device setting information S is completely read in the step G. Then, the controlling unit 33 is notified to perform the step I. In the step I, the personalized operating function of the input device 3 is updated according to the device setting information S. That is, the controlling unit 33 performs the input setting task corresponding to the device setting information S. The input setting task corresponding to the device setting information S is the task of defining the key combination of the composite key.

After the input setting task is completed, the input device 3 has the personalized operating function. Consequently, according to the usual practice of the user, the user can input the key combination of the composite key (e.g., the combination of the Q key, the W key and the E key) to the input device 3 through the input interface 31. Consequently, according to the contents of the device setting information S, the input interface 31 issues a personalized operating signal P to the computer host 4. According to the personalized operating signal P, the computer host 4 performs a corresponding operation.

The following two aspects should be specially described. Firstly, the input device 3 is a keyboard, and the input setting task is a task of defining a composite key command corresponding to plural keys of the input interface 31. The examples of the input device and the input setting task are presented herein for purpose of illustration and description only. For example, in another embodiment, the input device is an illuminated keyboard, and the input setting task is a task of defining an illuminating control command corresponding to a light-emitting element of the input device. For example, when the composite key or the hot key is depressed, the light-emitting element flicks in a specified manner. Alternatively, in another embodiment, the input device is a wheel mouse, and the input setting task is a task of defining a wheel function command corresponding to a scroll wheel of the input device. For example, when the scroll wheel is rotated for two turns, a specified command is executed.

Secondly, the personalized setting program may further contain a clear setting option (not shown). When the clear setting option is clicked by the user, a clear setting signal is generated, and the clear setting signal is transmitted from the personalized setting program to the near field communication controller through the antenna. In response to the clear setting signal, the near field communication controller notifies the controlling unit to cancel the input setting task and delete the device setting information. In case that the input device is used in a public place or the computer host is shared with others, the clearing function is feasible.

From the above descriptions, the input device of the present invention comprises the near field communication unit. The near field communication unit receives the device setting information from the portable electronic device. After the input setting task corresponding to the device setting information is implemented, the input device has the personalized operating function. Since the input setting task is performed by the controlling unit of the input device, it is not necessary to install a driver in the computer host. For transmitting the device setting information, the device setting information is temporarily stored in the portable electronic device that is carried by the user every day. Consequently, the possibility of forgetting to carry the device setting information (or the portable electronic device) will be minimized. Moreover, the input device of the present invention receives the device setting information by the near field communication technology, and the electric power to the near field communication unit of the input device is provided by the portable electronic device. Consequently, the input device has the power-saving benefit.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An input device connected with a computer host, the input device comprising:
an input interface, wherein the input interface issues an operating signal to the computer hot in response to an operation of a user on the input interface;
a near field communication unit receiving a device setting information and temporarily storing the device setting information; and
a controlling unit connected with the input interface and the near field communication unit, and reading the device setting information, wherein after an input setting task corresponding to the device setting information is performed on the input device by the controlling unit, a personalized operating signal corresponding to the device setting information is issued from the input interface to the computer system in response to the operation of the user.

2. The input device according to claim 1, wherein the near field communication unit comprises:
an antenna receiving the device setting information and electric power by a near field communication technology; and
a near field communication controller connected with the antenna, wherein the near field communication controller temporarily stores the device setting information and transmits the device setting information to the controlling unit, wherein the near field communication controller comprises:
a temporary memory connected with the antenna, and temporarily storing the device setting information;
a notification interface disposed on the near field communication controller and connected with the controlling unit, wherein the controlling unit is notified to read the device setting information from the near field communication controller through the notification interface; and
a reading interface disposed on the near field communication controller and connected with the controlling unit, wherein the controlling unit reads the device setting information from the near field communication controller through the reading interface.

3. The input device according to claim 2, wherein the antenna is in wireless communication with a portable electronic device by the near field communication technology, the portable electronic device comprises a near field communication module, and the antenna is in wireless communication with the near field communication module by the near field communication technology, wherein a personalized setting program is installed in the portable electronic device, and the personalized setting program generates the device setting information when the user operates the personalized setting program, wherein the device setting information is outputted through the near field communication module.

4. The input device according to claim 3, wherein when the near field communication module is in wireless communication with the antenna, the near field communication controller receives the electric power from the portable electronic device so as to be triggered, and an identification code corresponding to the input device is transmitted from the near field communication controller to the near field communication module through the antenna, wherein the personalized setting program searches the device setting information corresponding to the identification code from the portable electronic device according to the identification code.

5. The input device according to claim 4, wherein after the device setting information corresponding to the identification code is outputted from the personalized setting program to the antenna, the device setting information is temporarily stored in the temporary memory, and the near field communication controller judges whether the controlling unit is in a sleep mode, wherein if the near field communication controller judges that the controlling unit is not in the sleep mode, the near field communication controller notifies the controlling unit to read the device setting information through the notification interface, and the near field communication controller transmits the device setting information through the reading interface so as to allow the device setting information to be read by the controlling unit, wherein if the near field communication controller judges that the controlling unit is in the sleep mode, the near field communication controller wakes up the controlling unit through the notification interface, so that the controlling unit is waked up from the sleep mode.

6. The input device according to claim 3, wherein the personalized setting program contains a clear setting option, wherein when the clear setting option is clicked by the user, a clear setting signal is generated, and the clear setting signal is transmitted from the personalized setting program to the near field communication controller through the antenna, wherein in response to the clear setting signal, the near field communication controller notifies the controlling unit to cancel the input setting task and delete the device setting information.

7. The input device according to claim 2, wherein the temporary memory is a flash memory or an electrically-erasable programmable read-only memory (EEPROM).

8. The input device according to claim 1, wherein the input setting task includes a task of defining a composite key command corresponding to plural keys of the input interface, a task of defining an illuminating control command corresponding to at least one light-emitting element of the input device and/or a task of defining a wheel function command corresponding to a scroll wheel of the input device.
